(19) United States
(12) Patent Application Publication
(10) Pub. No.: US 2003/0157962 A1
(43) Pub. Date: Aug. 21, 2003

(54) Communication mode management system in a wireless communication environment

(76) Inventor: Jean Tourrilhes, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/079,606

(22) Filed: Feb. 21, 2002

(51) Int. Cl. H04M 1/00

(52) U.S. Cl. 455/557; 455/553; 455/556

(57) ABSTRACT

A system for changing operation mode of a first communication interface of a first device while in communication with a second device is described. The system includes a communication activator external to the first device to send a trigger signal when an external third device wants to communicate with the first device via the first interface. A second communication interface is located inside the first device to receive the trigger signal. An operation mode control module is coupled to the first and second interfaces to cause the first interface to change its operation mode in order to communicate with the third device when the second interface receives the trigger signal. A method for changing operation mode of a first communication interface of a first device while in communication with a second device is also described.

### BACKGROUND OF THE INVENTION

1. Field of the Invention

The present invention pertains to communication devices. More particularly, this invention relates to a communication mode management system that causes a wireless communication device to change its mode of operation during communication.

2. Description of the Related Art

Different wireless networks offer different characteristics. Local wireless communication links can be used to reach locally connected devices and/or systems. Wireless communication links can also be used to reach local infrastructures. A device with more than one wireless link can exploit this diversity by selecting the current best link for the specific network transaction it needs to perform. A common example of such a device is a cellular phone that includes support for Analog Modulation Phone System (AMPS) and Digital Modulation Phone System (DAMPS). The switching between the two systems depends on coverage. Another example is a portable computer that is equipped with an IrDA interface (i.e., directional infrared), a local radio network interface, and a long range cellular phone network interface.

FIG. 1 shows one prior art communication system 10 that includes a number of devices 12 through 14 that communicate with each other via a communication network 11. This communication system 10 can be a wireless communication system, or a wire-line communication system. If the communication system 10 is a wireless system, the network 11 can be an active network that receives communication signals from a sending device (e.g., the device 12) and then re-sends the signals to the appropriate receiving device (e.g., the device 14). The network 11 can also be a passive network which only includes the atmosphere.

Disadvantages are associated with this prior art connection-oriented or connection-based communication system. One disadvantage is that it tends to increase the connection latency between any two devices. Connection latency is from the time at which a device is requesting the connection with another device until the time at which the requesting device is connected to the requested device. The connection latency is typically increased when the requested device is actually in communication with another device. At this time, the requested device cannot handle or accept communication request from the requesting device. The requesting device has to wait until after the requested device has finished communicating with the other device. This typically increases the connection latency.

Another disadvantage is that the prior art communication system also does not allow for any mechanism to join additional devices into existing communication and/or conferencing. For example, when the device 12 of FIG. 1 is communicating with the device 13 and the device 14 wants to join in the communication, the device 12 can receive such a request only after its communication with the device 13 is completed or suspended. This is especially so when the communication system is a wireless communication system in which the devices that are in communication are typically “tuned” (or connected) to each other. In this case, the requesting device has to wait until the existing communication is completed or suspended. Some existing communication technology (e.g., the Bluetooth) may call for a device in communication to periodically suspend its current communication operation to check for any device that is requesting communication. This, however, still does not solve the connection latency issue because the device only does the check periodically, not whenever such a request is generated.

Thus, there exists a need to create a scheme that causes some wireless communication devices to change their mode of operation during communication. This in turn will allow for reduced connection latency and improved user experience in a mobile wireless communication environment.

### SUMMARY OF THE INVENTION

One feature of the present invention is to minimize connection latency between communication devices.

Another feature of the present invention is to allow for fast discovery of new peers and infrastructure by a communication device.

A system for changing operation mode of a first communication interface of a first device while in communication with a second device includes a communication activator external to the first device to send a trigger signal when an external third device wants to communicate with the first device via the first interface. A second communication interface is located inside the first device to receive the trigger signal. An operation mode control module is coupled to the first and second interfaces to cause the first interface to change its operation mode in order to communicate with the third device when the second interface receives the trigger signal.

A method for changing operation mode of a first communication interface of a first device in communication with a second device includes the step of generating a trigger signal from a communication activator external to the first device when an external third device wants to communicate with the first device via the first interface. The trigger signal is received by a second communication interface inside the device. The first communication interface is then caused by an operation mode control module to change its operation mode in order to communicate with the third device when the second interface receives the trigger signal.

### BRIEF DESCRIPTION OF THE DRAWINGS

FIG. 1 shows a prior art communication network system that includes a network and a number of communication devices.

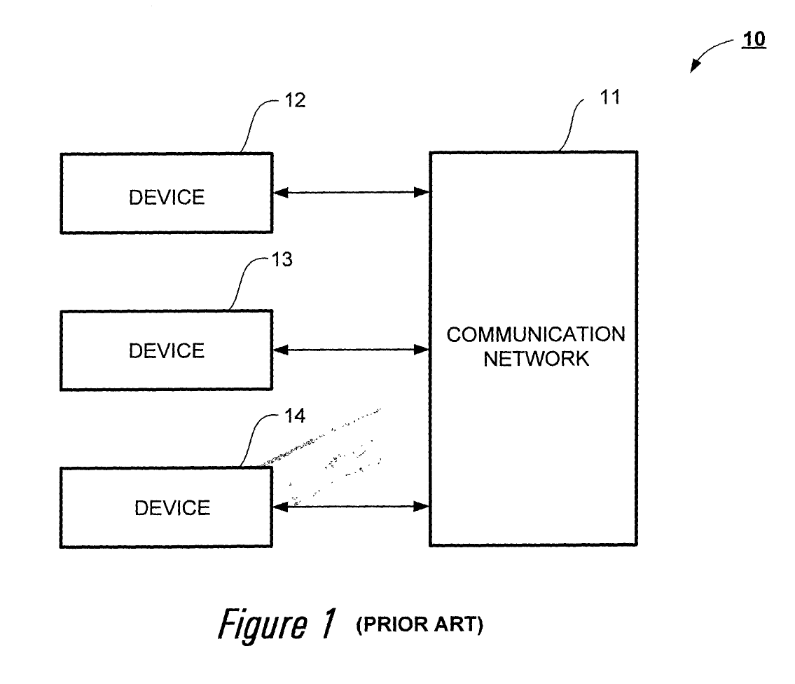

FIG. 2 schematically shows a communication management system that causes a communication device to change its mode of operation during communication in accordance with one embodiment of the present invention.

FIG. 3 shows in flow chart diagram form the process of the operation mode control module of the communication management system of FIG. 2.

FIG. 4 shows in flow chart diagram form the process of the second network interface of the communication management system of FIG. 2.

### DETAILED DESCRIPTION OF THE INVENTION

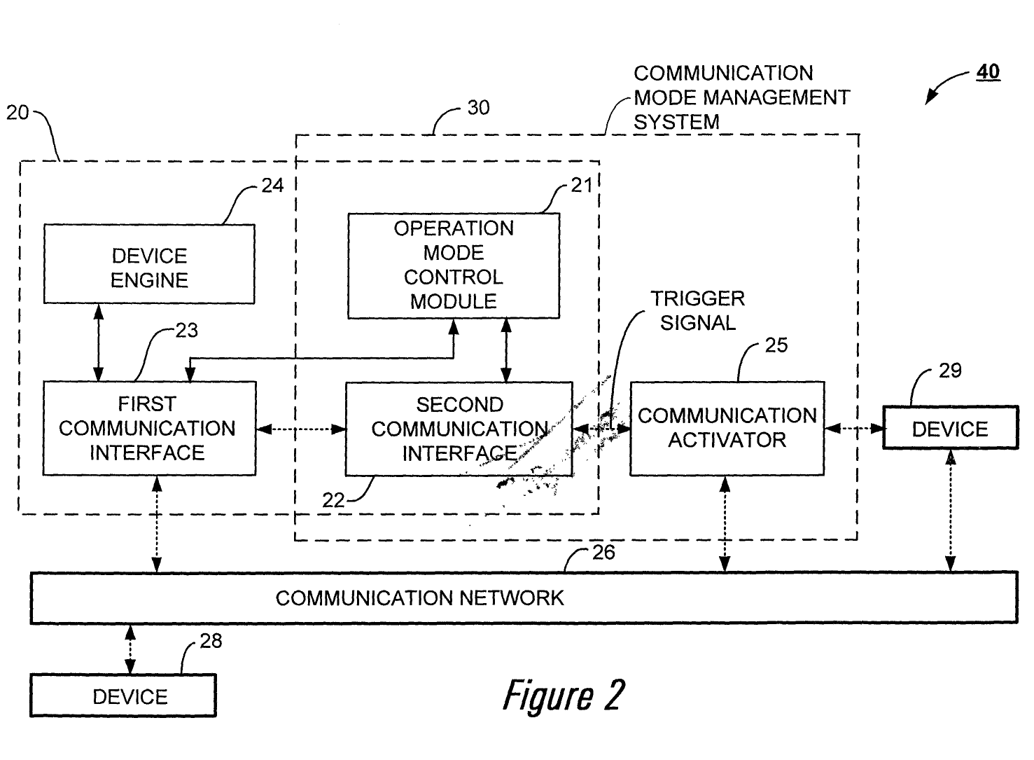

FIG. 2 shows a communication management system 30 in a communication network system 40. The communication management system 30 implements one embodiment of the present invention, which will be described in more detail below.

As can be seen from FIG. 2, the communication network system 40 includes a number of electronic devices that can communicate with each other via a network (i.e., the network 26). FIG. 2 only shows the electronic devices 20 and 28-29. In practice, the communication network system 40 may include more devices than those shown in FIG. 2. Each of the devices 20 and 28-29 is equipped with wireless communication capability and can establish wireless communication with one another via the communication network 26. This means that each of the devices 20 and 28-29 includes a communication interface (e.g., the first communication interface 23) that allows its device to communicate with other devices of the communication systems 40 via the network 26. FIG. 2 only shows the interface 23 in the device 20. In fact, each of the devices 28-29 includes such a communication interface as the interface 23.

In accordance with one embodiment of the present invention, the communication management system 30 changes the mode of operation of an electronic device (e.g., the device 20) which is in communication with another device (e.g., the device 28) when a third device (e.g.,the device 29) is requesting to communicate with the device 20 such that the device 20 can attend to the device 29 with minimized connection latency. This also allows the requesting device 29 to join the existing communication between the devices 20 and 28, if desired.

The communication management system 30 achieves the above by having an operation mode control module 21 inside the device 20 to cause the mode of operation of the first communication interface 23 to be changed. The control module 21 initiates the mode change when it receives a trigger signal from a second communication interface 22 also inside the device 20. The second communication interface 22 receives the trigger signal from a communication activator 25 external to the device 20. The communication activator 25 generates and sends the trigger signal when the device 29 wants to communicate with the device 20 through the first communication interface 23 when the device 20 is in communication with the device 28 via the first interface 23. The control module 21, the second interface 22 and the activator 25 are all part of the communication mode management system 30.

One main advantage of the communication mode management system 30 is that it minimizes the connection latency. Another advantage is that the system 30 allows the device 29 to be able to join the existing communication between the devices 20 and 28. The shortened connection latency and the ability to allow the device 29 to join the existing communication in turn improve the user experience. The communication management system 30 will be described in more detail below, also in conjunction with FIGS. 2-4.

In FIG. 2, each of the devices 20 and 28-29 can be any kind of portable or mobile electronic device. In one embodiment, each of the devices 20 and 28-29 is a pager or a watch. In another embodiment, each of the devices 20 and 28-29 is a cellular phone or satellite phone. In a further embodiment, each of the devices 20 and 28-29 is a palm-top computer, a personal digital assistant, a personal organizer, or a mobile computer. In a still further embodiment, each of the devices 20 and 28-29 can be a computer system. Alternatively, each of the devices 20 and 28-29 can be any kind of information appliance, mobile computer system, or any kind of small portable handheld electronic device or appliance.

The device 20 includes a device engine 24 in addition to the first communication interface 23. Both components reside inside the device 20. The device engine 24 is used to perform the main function of the device 20. Thus, the structure of the device engine 24 depends on the type of the device 20. For example, if the device 20 is a printer, then the device engine 24 is a printer system. If the device 20 is a computer, then the device engine 24 is a computer system. If the device 20 is an information appliance (e.g., Internet radio), then the device engine 24 implements that function.

The first interface 23 allows the device 20 to communicate with external devices (e.g., the devices 28-29) via the external network 26. The external network 26 is external to the device 20 and, when connection established, communicates with the device 20 through the network interface 23 wirelessly. The external network 26 can be a network of wireless communication systems that receives communication signals from a sending device and then re-sends the signals. The external network 26 can also be a single wireless device for connection with the device 20 (i.e., peer to peer connection). Moreover, the external network 26 can be a passive network which only includes the atmosphere.

If the external network 26 is implemented by a network of connected wireless communication systems, any device/system within the network 26 may be functioning as the gateway to interface with the device 20 via the network interface 23. In this case, the establishment of communication of the device 20 with the network 26 means having the device 20 communicate with any one of the devices/systems within the network 26.

In one embodiment, the communication network system 40 is a radio frequency communication system. In this case, the frequency used for communication among the devices 20 and 28-29 and the network 26 can be a long range radio frequency or short range radio frequency. In another embodiment, the communication network system 40 is a laser communication system. In a further embodiment, the communication network system 40 is an Infra-red communication system.

The first interface 23 can be of any known wireless network interface and can be implemented using any known technology. In one embodiment, the interface 23 is a radio frequency communication interface. In this case, the frequency can be a long range radio frequency or short range radio frequency. In another embodiment, the interface 23 is a laser communication interface. In a further embodiment, the interface 23 is an Infra-red communication interface.

The communication protocol used for the wireless communication between the network 26 and the network interface 23 of the device 20 can be any known communication protocol, and only depends on the communication means employed. For example, if the network 26 and the network interface 23 employ the Infra-red communication technology for the wireless communication, then the communication protocol can be an IrDA (Infrared Data Association) protocol or TCP/IP protocol.

As can be seen from FIG. 2, the activator 25 of the communication mode management system 30 is located external to the device 20 and also external to the network 26. In one embodiment, the activator 25 is located in the device 29. This means that each of the devices 20 and 28-29 has such an activator.

In another embodiment, the activator 25 is external to any of the devices 20 and 28-29. In this case, the activator 25 functions as a central unit that generates the trigger signal whenever it receives a request from any one of the devices 20 and 28-29. A device (e.g., the device 29) generates the request whenever it wants to join an existing communication, or it wants to communicate with a device (e.g., the device 20) that is in communication with another device. The request can then be communicated to the activator 25 from the requesting device via the network 26. The activator 25 can be implemented by any known technology. For example, the activator 25 can also be a piece of software in a device (e.g., PDA) that wants to communicate with the device 20.

The second network interface 22 is located inside the device 20. This means that the communication mode management 30 includes modules inside the device 20, as well as modules (e.g., the activator 25) outside the device 20. The activator 25 communicates with the second network interface 22 wirelessly. The activator 25 may also communicate with the network 26, either wirelessly or via wired communication channel.

The activator 25 generates the trigger signal whenever a device (e.g., the device 29) wants to communicate with the device 20 via the first interface 23 of the device 20 when the device 20 is in communication with another device (e.g., the device 28). The activator 25 then transmits the trigger signal out.

In one embodiment, the transmission is done by the activator 25 in the form of regular broadcast (e.g., like a beacon). In this case, the activator 25 is typically located close to the device 29 such that when the device 20 is close to the device 29 and the device 29 wants to communicate with the device 20, the second network interface 22 can receive the broadcast of the trigger signal. In another embodiment, the transmission is done only when the second network interface 22 has established connection with the activator 25.

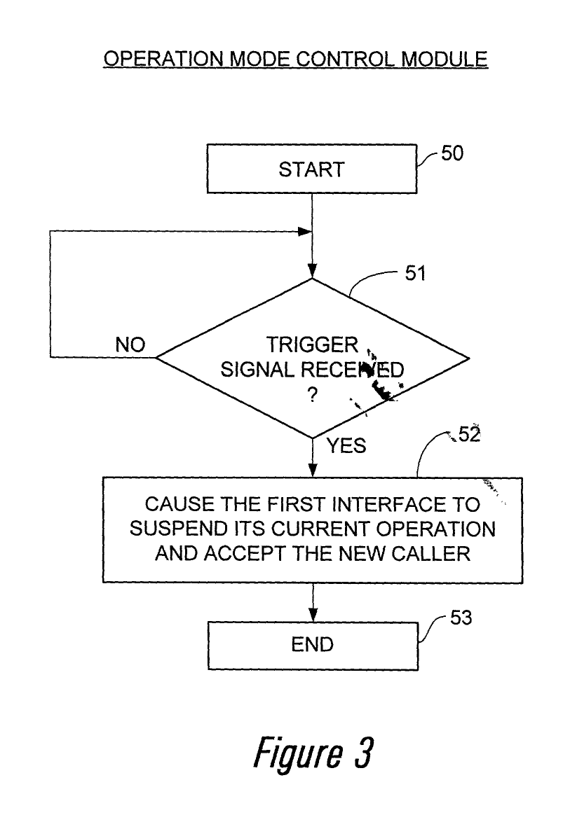

When the second network interface 22 receives the trigger signal, the signal is passed to the operation mode control module 21. The operation mode control module 21 is also located inside the device 20. The function of the operation mode control module 21 is to change the operation mode of the first communication interface 23. This includes (1) suspending the current communication operation of the first interface 23, and (2) establishing communication with the requesting device (e.g., the device 29). The establishing communication operation may include (1) terminating the existing communication with the device 28 and to establish the communication with the requesting device 29, or (2) allowing the device 29 to join in the existing communication as a new caller. Which of the approaches the interface 23 will take depends on whether the device 29 wants to just communicate with the device 20 or to join the existing communication between the devices 20 and 28. FIG. 3 shows in more detail the process or operation of the operation mode control module 21, which will be described in more detail below.

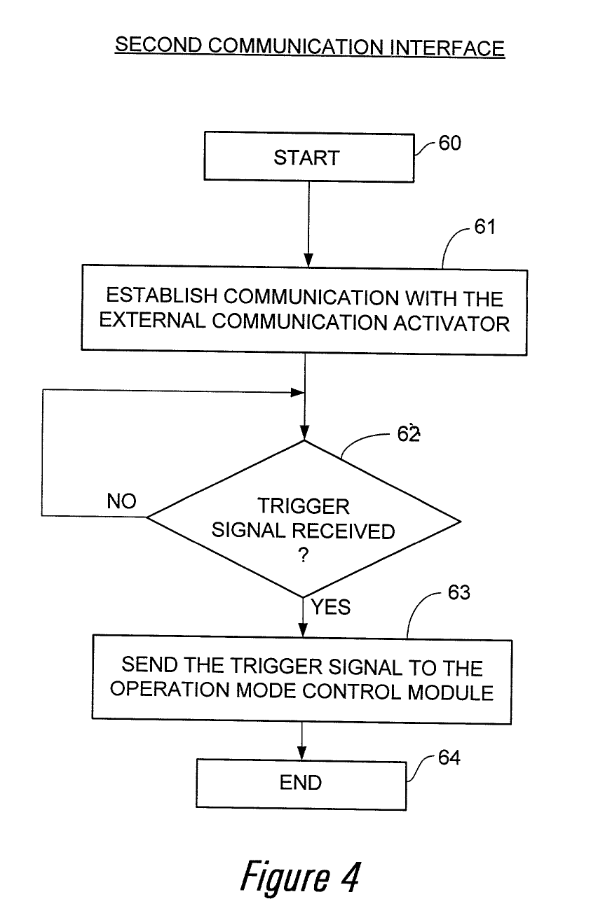

Referring again to FIG. 2, the structure of the second interface 22 is substantially the same as that of the first interface 23 in that both contain the physical layer, the link layer, the network layer, and the transport layer. The characteristics of the second interface 22 may or may not be different from that of the first interface 23. This means that the second interface 22 may have shorter latency for discovering new devices and establishing communication with the newly discovered device. Some communication technologies have the ability to receive new connection requests while already in communication. Typically, these technologies use a broadcast medium as opposed to connection-oriented medium. One possible pair of communication means for the two interfaces 22-23 can be (1) radio frequency for the wireless network interface 23 and (2) Infrared for the interface 22. Another pair can be that the interface 23 is a long or medium range radio frequency wireless communication interface while the interface 22 is a short range radio frequency wireless communication interface. A third possible pair can be laser for the interface 23 while infra-red for the interface 22. FIG. 4 shows in more detail the process or operation of the second network interface 22, which will be described in more detail below.

Referring to FIG. 3, the process of the operation mode control module 21 of FIG. 2 starts at the step 50. At the step 51, the operation mode control module 21 detects if any trigger signal is received from the external activator 25 (FIG. 2). As described above, the activator 25 sends the trigger signal if its associated device 29 wants to communicate with the device 20 (or wants to join the existing communication of the device 20 as a new caller) while the device 20 is in communication with the device 28.

If no trigger signal is received, then the step 51 is repeated. If the trigger signal is received, then the step 52 is performed, at which the operation mode control module 21 causes the first interface 23 to suspend its current operation to handle the request from the device 29. In this case, there are two approaches that the first interface 23 can do. One is to terminate the communication with the device 28 and to establish the communication with the requesting device 29. The other is to only suspend the communication with the device 28 and then accept the device 29 into the communication as a new caller. Which of the approaches the interface 23 will take depends on whether the device 29 wants to just communicate with the device 20 or to join the existing communication between the devices 20 and 28. The process then ends at the step 53.

Referring to FIG. 4, the process of the secondary wireless network interface 22 of FIG. 2 in obtaining and passing the trigger signal is shown. The process starts at the step 60. At the step 61, the interface 22 establishes the communication with the external activator 25. In one embodiment, the interface 22 achieves this by broadcasting the request. In another embodiment, the interface 22 discovers the activator 25 and then connects to it. The discovery process can be done in known manner. For example, the IrDA protocol allows automatic discovery of new communication port in range. This means that if the interface 22 and the activator 25 employ the IrDA infra-red (or Bluetooth short range radio) communication, the protocol will allow the activator 25 to automatically detect the interface 22 if the interface 22 is in the communication range. Once communication is established with the interface 22, the activator 25 sends the trigger signal to the network interface 22. Alternatively, the step 61 can be skipped by the interface 22 and the interface 22 automatically receives the trigger signal from the activator 25 when the interface 22 is close to the activator 25.

At the step 62, the interface 22 determines whether the trigger signal has been received. If no, the step 62 is repeated. If so, the step 63 is performed. At the step 63, the interface 22 sends the trigger signal to the operation mode control module 21 for changing the operation mode of the interface 23. The process then ends at the step 64.

What is claimed is:

1. A system for changing operation mode of a first communication interface of a first device in communication with a second device, comprising:
a communication activator external to the first device to send a trigger signal when an external third device wants to communicate with the first device via the first interface;
a second communication interface inside the first device to receive the trigger signal;
an operation mode control module coupled to the first and second interfaces to cause the first interface to change its operation mode in order to communicate with the third device when the second interface receives the trigger signal.

2. The system of claim 1, wherein the communication activator is inside the third device that also includes a first communication interface and a second communication interface, wherein the communication activator sends the trigger signal through the second communication interface of the third device.

3. The system of claim 1, wherein the communication activator is located external to the third device.

4. The system of claim 1, wherein the operation mode of the first interface of the first device is changed to (1) suspend its current exclusive communication with the second device and (2) include the third device in its communication such that the first, second, and third devices are in communication together.

5. The system of claim 1, wherein the operation mode of the first interface of the first device is changed to (1) suspend its current communication with the second device and (2) establish communication with the third device.

6. The system of claim 1, wherein the first and second communication interfaces employ different wireless communication technologies.

7. The system of claim 6, wherein each of the first and second communication interfaces employs a wireless communication technology selected from a group comprising infrared communication technology, laser communication technology, short range radio frequency communication technology, and long range radio frequency communication technology.

8. A method for changing operation mode of a first communication interface of a first device in communication with a second device, comprising:
(A) generating a trigger signal from a communication activator external to the first device when an external third device wants to communicate with the first device via the first interface;
(B) receiving the trigger signal by a second communication interface inside the device;
(C) causing the first communication interface to change its operation mode in order to communicate with the third device when the second interface receives the trigger signal.

9. The method of claim 8, wherein the communication activator is inside the third device that also includes a first communication interface and a second communication interface, wherein the communication activator sends the trigger signal through the second communication interface of the third device.

10. The method of claim 8, wherein the communication activator is located external to the third device.

11. The method of claim 8, wherein the step (C) is performed by
suspending the current exclusive communication of the first interface with the second device; and
including the third device in the communication such that the first, second, and third devices are in communication together.

12. The method of claim 8, wherein the step (C) is performed by
suspending the current communication of the first interface of the first device with the second device;
establishing communication with the third device.

13. The method of claim 8, wherein the first and second communication interfaces employ different wireless communication technologies.

14. The method of claim 8, wherein each of the first and second communication interfaces employs a wireless communication technology selected from a group comprising infrared communication technology, laser communication technology, short range radio frequency communication technology, and long range radio frequency communication technology.
